(19) United States
(12) Patent Application Publication
(10) Pub. No.: US 2002/0087783 A1
(43) Pub. Date: Jul. 4, 2002

(54) Low cost, high performance tape drive

(75) Inventors: Michael L. Leonhardt, Longmont, CO (US); Thai Nguyen, Thornton, CO (US); Stephen S. Selkirk, Broomfield, CO (US); Charles A. Milligan, Golden, CO (US)

Correspondence Address: Wayne P. Bailey, Storage Technology Corporation, One StorageTek Drive, Louisville, CO, 80028-4309, US

(73) Assignee: Storage Technology Corporation

(21) Appl. No.: 09/751,755

(22) Filed: Dec. 29, 2000

(51) Int. Cl. G06F 13/00

(52) U.S. Cl. 711/111; 711/154

(57) ABSTRACT

An improved tape drive is provided. In one embodiment, the tape drive includes read/write heads for reading data from a tape, a disk drive communicably coupled to the read/write heads, and an interface communicably coupled to the read/write heads and to the disk drive for allowing the tape drive to exchange data with a host computer. The disk drive stores data received from a host during time periods when a tape is being retrieved and loaded onto the tape drive such that the host computer may begin sending data to the tape drive prior to the tape being mounted on the tape drive. Once the tape is mounted, the data received from the host computer is written directly to the tape with space reserved on the tape for writing the initial data received from the host computer that is stored on the disk drive. Once the tape drive has finished writing all but the initial data to the tape, the tape is repositioned and the initial data is written to the tape from the disk drive onto the reserved portion of the tape.

### BACKGROUND OF THE INVENTION

1. Technical Field

The present invention relates to tape system for reading data from and writing data to and from storage media.

2. Description of Related Art

Magnetic tape is a widely used data storage media. Tape drives and their corresponding tape media are applied to data storage tasks in all levels of computer data storage from personal computers to workstations to mainframes and supercomputers. Much of magnetic tape's popularity is due to the fact that is offers the lowest cost per unit of storage and highest volumetric storage efficiency of all available technologies. Tape products are available in many formats from many vendors in a wide range of cost categories ranging from less than one hundred to many ten's of thousands of dollars.

In general, the lowest cost drives are applied to the lowest cost computer systems (personal computers, for instance) and deliver the lowest performance. Highest cost drivers are utilized in the highest cost computer systems. Common performance metrics include capacity, data rate, access time and reliability. Typically, as the cost of tape drives increases, their performance increases—i.e. higher capacity, data rates, and reliability with reduced access times.

Automated tape media handling systems complement tape drives and have become commonplace in the data storage industry—offering the increased performance of tape cartridge loading and unloading robotically in and out of tape drives. Automation has turned magnetic tape from an “off-line” storage device requiring human intervention (typically taking minutes) to load and unload tape to a more “near online” system termed “nearline” (typically taking seconds). Nearline tape systems combine the desirable low cost of tape storage with access times longer than traditional “online” disk or solid state based data storage systems but fast enough to meet many online performance requirements with lower storage cost. With the nearline class of storage and the speed of robotics, the tape drive's access time, the time to load a tape cartridge then locate and access its data, has become a significant performance parameter.

To respond to the demands of the competitive marketplace it is vital to develop and offer products that have the highest performance at the lowest cost. Design trade-offs are made to balance cost against performance. Consider an example.

To increase access time performance, latencies must be decreased; therefore tape must be handled more rapidly. This requires more powerful, larger motors in the tape drive to increase tape acceleration rates. The motor control electronics must be able to handle higher peak currents and power dissipation. Cooling for the drive may need to be improved leading to larger fans. The power supply may have to be made larger to handle increased power demands. The tape path may require added complexity to maintain tape integrity over the higher accelerations. The trade-off to decrease access time has added cost, size and complexity and may reduce overall drive reliability.

What is desired is an approach to increase tape drive access performance without having to resort to the above measures and minimize product cost, size, and complexity while maximizing reliability.

### SUMMARY OF THE INVENTION

The present invention provides a removable media system such as a tape drive system with improved performance. In a preferred embodiment a tape based storage function is combined with a random access based storage function (also referred to as random access function or RAF) to provide unique and enhanced data storage capabilities at attractive cost-performance points in an industry standard form factor. This invention also applies where a different removable media technology such as optical disc, optical tape or holography is used in place of magnetic tape.

The random access storage function receives and stores data received from a host computer system or network (also referred to as host computer or host or host computer system) during time periods when the tape storage function is unavailable for reading or writing the media. Unavailability of tape data storage can occur while a manual or robotic system is in the process of retrieving a tape from physical storage and loading the tape into the tape storage function. In this instance the tape drive's access time for writing is the latency to ready the random access storage function to accept data—typically <3 seconds and as fast as 10's of milliseconds. Unavailability can also occur when the tape drive is positioning the media to a specific location in preparation for read or write as with a ‘space’ command. In this instance, the random access storage function can be used as a copy or a cache of the impending read or write. If the first ‘n’ bytes of a file are stored in the random access facility rather than (or in addition to) being stored on the tape media at the location being accessed via the ‘space’ command, the read or write command can execute in parallel with the physical motion.

The random access storage function may be chosen by an operational mode to receive data in place of the tape storage and may also be chosen to receive data when an operational mode has been selected to store data files or a portion of those files on both random access and tape. Alternatively, pre-staging policies anticipate data usage and specify the data be transferred from the tape to the random access storage function. When data is to be retrieved from the tape drive, and this data is available from the random access storage function, access time to data can be as fast as 10's of milliseconds.

In instances where the random access storage function is not available, the tape storage function receives the data for storage. For data retrievals where the data is not available on the random access storage function, it is retrieved from the tape storage function. Data storage policies direct the storage and retrieval of data to, from and between the tape and random access storage functions of the present tape drive system invention.

This tape drive system offers access time characteristics for many data write and retrieve functions that rivals all existing tape drive products. These performance gains are attained by the system's unique architecture utilizing both tape and random access storage components. By allowing a tape storage system to function with enhanced native characteristics as described in the last section, low system cost along with enhanced access time performance is attained.

This system is made practical by the availability of very low cost disk drives for the consumer electronics business sector. Such a drive provides the random access storage function.

Other technologies can provide the random access function as well. These include solid state memory and micro electrical mechanical (MEMS)-probe systems (a solid state—mechanical hybrid system with faster access times, lower power requirements and generally smaller size than magnetic disk drives).

Another approach to the combination of the tape based-random accessed storage function is to include the random access function with the tape storage unit (e.g., a cartridge) as well as or instead of in the tape drive. The random access function is used to store the first part or the data in a file, while the remaining file data is stored on the tape media in the same cartridge. This provides improved performance in that the portion of the data file on the random access storage function can be read while the tape media is still being physically positioned into the drives tape path. This cartridge based random access storage function could be provided by a miniature disk drive, MEMS-probe module, solid state memory or the like.

Another approach is to incorporate a combination of data, control and power connections in the robotic handling system such that the cartridge's random access function is accessed as soon as the cartridge is gripped by the robot. Using this approach, data can be transferred to or from the random access function during transport to or from its storage location to the tape drive.

Yet another approach is to provide a combination of data, control and power connections to the cartridge storage location itself. In this way, the random access function of the cartridge is accessible during storage periods. Furthermore, using this approach, exchange of data between stored cartridges, cartridges and host computer system as well as cartridges and tape drives is possible.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an automated cartridge system (ACS) in which the present invention may be implemented;

FIG. 2 depicts a top view of the overall architecture of a typical automated robotic tape library storage module wherein the tape drive of the present invention may be employed;

FIG. 3 depicts a side view of a segment of an LSM in accordance with the present invention;

FIG. 4 depicts a block diagram of a data processing system which may be used in conjunction with the tape drive of the present invention;

FIG. 5 depicts a block diagram of a tape drive in accordance with the present invention;

FIG. 6 depicts a schematic diagram of a section of tape illustrating a method of writing data to tape in accordance with the present invention;

FIG. 7 depicts a schematic diagram of a section of a tape illustrating the retrieval of files from a tape in accordance with the present invention;

FIG. 8A depicts a flowchart illustrating an exemplary method of writing data to tape using the tape drive of the present invention;

FIG. 8B depicts a flowchart illustrating an exemplary method of writing data to tape using the tape drive of the present invention;

FIG. 9 depicts a flowchart illustrating an exemplary method of reading an entire tape from a tape drive according to the present invention;

FIG. 10 depicts a flowchart illustrating an exemplary method of retrieving specific data files from a tape using a tape drive according to the present invention;

FIG. 11 depicts a schematic diagram of a double RAF system in accordance with the present invention; and

FIG. 12 depicts a schematic diagram of a tape cartridge for use with a double RAF system in accordance with the present invention.

### DETAILED DESCRIPTION OF THE PREFERRED EMBODIMENT

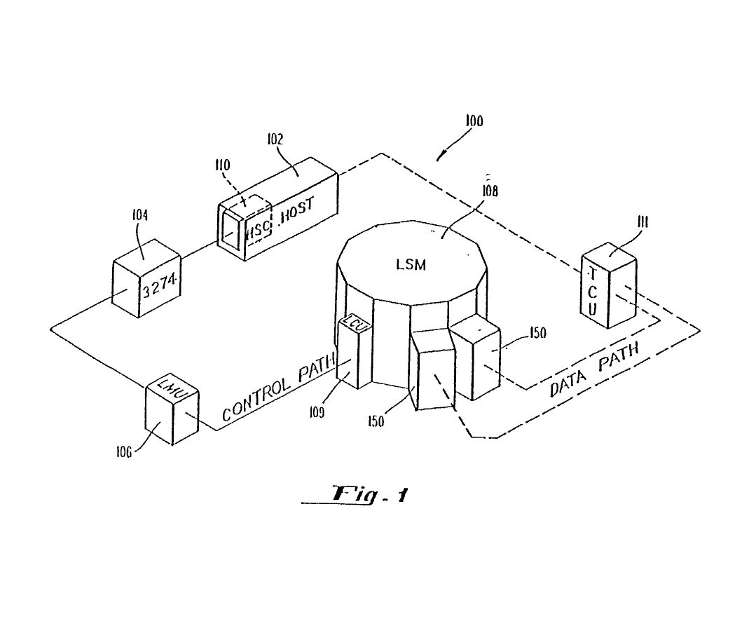

With reference now to the figures, wherein like characters designate like or corresponding parts throughout the several views, there is shown in FIG. 1 an automated cartridge system (ACS) 100 in which the present invention may be implemented. The ACS 100 is designed to operate with an IBM, or IBM-compatible host computer 102 capable of communication with a conventional 327X-type terminal controller 104 as will be described in further detail herein below. Comprised generally of a library management unit (LMU) 106 and a library storage module (LSM) 108, the ACS 100, through its associated host software component (HSC) 110, enables storage and retrieval of magnetic tape cartridges for use by the host computer 102 across a conventional channel 112.

Each LMU 106 serves as the library controller and provides the interface between from one to sixteen host computers 102 and up to 16 LSMs 108.

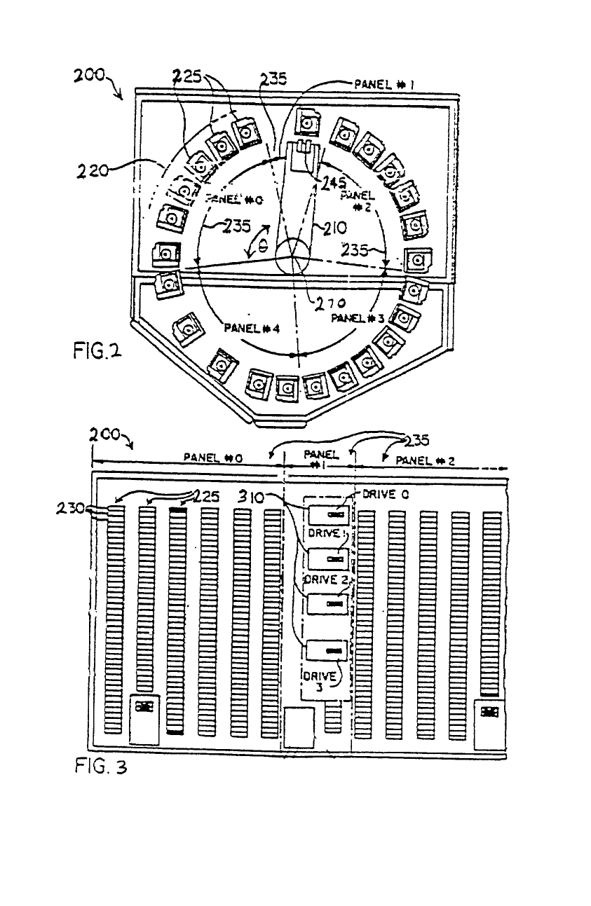

With reference to FIG. 2, a top view of the overall architecture of a typical automated robotic tape library storage module (LSM) 200 wherein the tape drive of the present invention may be employed is depicted. LSM 200 may be implemented as, for example, LSM 108 in FIG. 1. A typical automated library system operates to store and retrieve a large number of magnetic tape cartridges for an associated host processor. LSM 200 includes an array 220 of circularly arranged cells 230 for storing magnetic tape cartridges. A robotic arm 210 is pivotally rotatable about the center of array 220 and contains a tape cartridge retrieval mechanism 245.

Referring now to FIG. 3, a side view of a segment of LSM 200 is depicted in accordance with the present invention. Tape cartridge retrieval mechanism 245 is located in a position for retrieving and replacing tape cartridges in the tape cartridge storage cells 230. The retrieved tape cartridges are loaded into a tape transport mechanism (tape drives) 310 in response to a read/write request from a host computer (not shown) which is connected to LSM 200. Tape cartridge storage cells 230 and tape drives 310 are arranged in columns 225 which are grouped in “panels” 235.

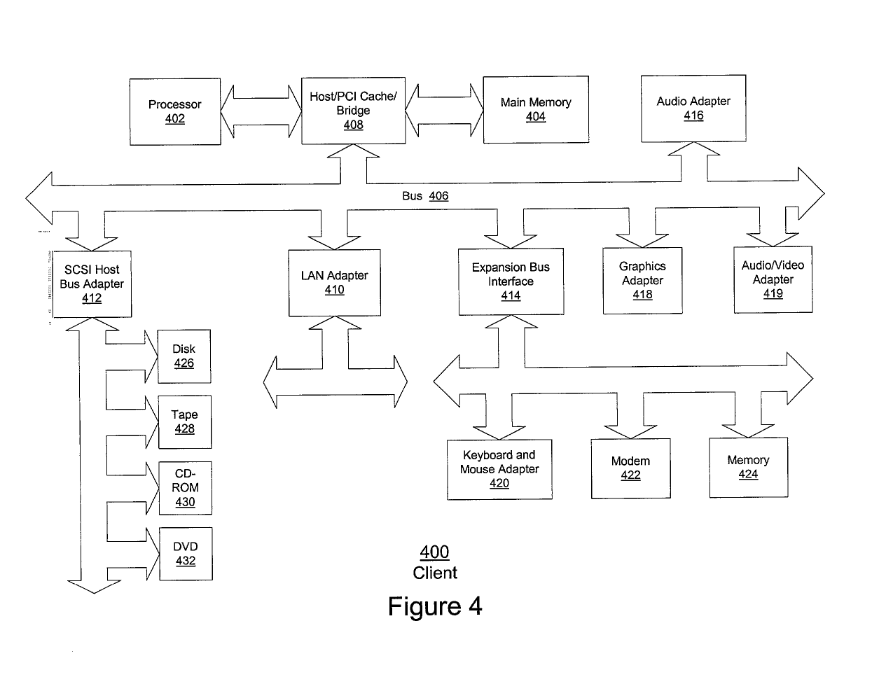

With reference now to FIG. 4, a block diagram of a data processing system which may be used in conjunction with the tape drive of the present invention is depicted. Data processing system 400 is an example of a host computer, such as, for example, host computer 102 in FIG. 1. Data processing system 400 employs a peripheral component interconnect (PCI) local bus architecture. Although the depicted example employs a PCI bus, other bus architectures, such as Micro Channel and ISA, may be used. Processor 402 and main memory 404 are connected to PCI local bus 406 through PCI bridge 408. PCI bridge 408 may also include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter (A/V) 419 are connected to PCI local bus 406 by add-in boards inserted into expansion slots. Expansion bus interface 414 provides a connection for a keyboard and mouse adapter 420, modem 422, and additional memory 424. In the depicted example, SCSI host bus adapter 412 provides a connection for hard disk drive 426, tape drive 428, CD-ROM drive 430, and digital video disc read only memory drive (DVD-ROM) 432. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as OS/2, which is available from International Business Machines Corporation. “OS/2” is a trademark of International Business Machines Corporation. An object-oriented programming system, such as Java, may run in conjunction with the operating system, providing calls to the operating system from Java programs or applications executing on data processing system 400. Instructions for the operating system, the object-oriented operating system, and applications or programs are located on a storage device, such as hard disk drive 426, and may be loaded into main memory 404 for execution by processor 402.

Those of ordinary skill in the art will appreciate that the hardware in FIG. 4 may vary depending on the implementation. For example, other peripheral devices, such as optical disk drives and the like, may be used in addition to or in place of the hardware depicted in FIG. 4. The depicted example is not meant to imply architectural limitations with respect to the present invention. For example, the processes of the present invention may be applied to multiprocessor data processing systems.

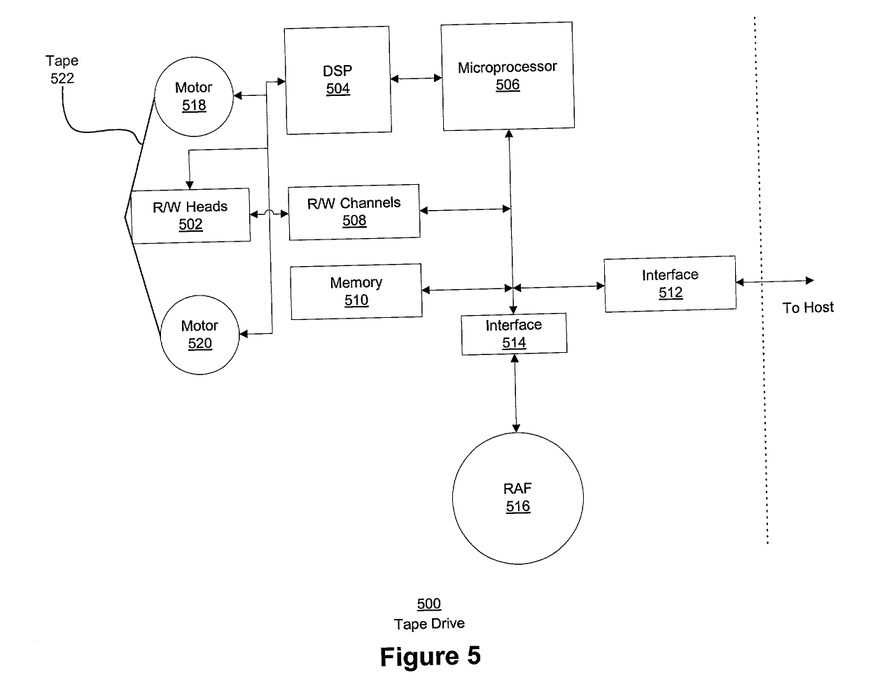

With reference now to FIG. 5, a block diagram of a tape drive in accordance with the present invention is depicted. Tape drive 500 may be implemented as, for example, one of tape drives 310 depicted in FIG. 3. Tape drive 500 includes a microprocessor 506, DSP 504, Read/write heads 502, read/write channels 508, memory 510, motors 518-520, interfaces 512-514 and random access function (RAF) 516. The terms random access function, random access storage function, and RAF are used interchangeably throughout the description of the present invention.

Microprocessor 506 executes instructions stored within memory 510 that control the functions of the other components within tape drive 500 such that read and write functions may be executed. Interface 512 provided an interface to allow tape drive 500 to communicate with a host computer, such as, for example, host computer 102 in FIG. 1, or with a host network. Motors 518-520, controlled by digital signal processor (DSP) 504, move tape 522 such that read/write heads 502 can read information from or write information to tape 522. During write operations, read-write channels (R/W channels) 508 provide for the reliable conversion of digital data into analog signals that drive the elements of recording head 502. Head 502 creates magnetic patterns on tape 522 as it is moved past. The conversion process includes the generation and appending of error correcting data to the digital data stream that is used during readback to help assure that data errors are detected and corrected.

During readback, R/W channels 508 process the analog head signals created by head 502 as tape 522 is moved past. The channels extract the data, detect and correct errors, and provide a digital data stream to microprocessor 506, memory 510, and interfaces 512, 514.

Interface 514 provides a data and control signal connection between components of tape drive 500, such as, for example, read/write channels 508, RAF 516. RAF 516 may be provided by, for example, a miniature disk drive, a MEMS-probe module, solid state memory or the like and may be used as a holding buffer or as a pass through buffer. As a holding buffer, RAF 516 is used such that during write to tape operations, the first portions of a stream of data that is to be written from the host computer system or network to tape is recorded onto RAF 516. After the appropriate tape has been retrieved from the library, such as, for example, LSM 108 in FIG. 1, loaded onto tape drive 500, and is ready to accept data, the tape 522 is advanced by an appropriate length to reserve a location for the data written to RAF 516 and the remaining data in the data stream is written directly to tape 522. Once the remaining data in the data stream is written to tape 522, tape 522 is repositioned to the beginning of the reserved location and the first portion of the data stream previously recorded to RAF 516 is written to tape 522. However, during the process of repositioning tape 522 and writing data from RAF 516 to tape 522, the host computer or network is free to execute other operations.

To speed up reading from the tape 522, a portion of data written to RAF 516 early in the process can be kept on RAF 516 indefinitely with an indication that it is part of the volume of data stored on tape 522. Thus, when the host computer or network wishes to retrieve (read) the data from tape 522, the first portion of data previously stored on RAF 516 can be sent to the host computer or network during the time that the tape drive 500 is waiting for tape 522 to be retrieved and mounted. Then the remaining data can be read and retrieved from tape 522. During writing to tape 522, an identifying marking or separator such as a file mark can be placed on tape 522 at the point at which data starts to be sent to the tape 522 rather than to RAF 516 such that during reading of tape 522, the tape can be advanced to the marking as the place to begin reading data that the host computer or network wishes to retrieve. In this manner, tape drive 500 can avoid reading data from tape 522 that is already contained on RAF 516, thus speeding up the retrieval of data for the host computer or network. If, however, for some reason, the data written to RAF 516 has been lost, the data is still available on the initial lead reserved portion of tape 522 and can be retrieved by the host computer or network.

In other embodiments, rather than writing to RAF 516 until tape 522 is ready to be written to, if RAF 516 has sufficient band width, the host computer or network can continue to write to RAF 516 even after tape 522 is ready to be written to and RAF 516 can write to tape 522 while simultaneously being written to by the host computer or network.

As a pass through buffer, the RAF 516 would initially be used in the same fashion as in the case of a holding buffer. However, when the tape cartridge is mounted, the tape media is not positioned to write the next byte from the host computer or network but is positioned to write the first byte of data that was stored in the RAF 516 sequentially. Concurrently, the data is read from the RAF 516 starting with the first byte received from the host computer or network and written to the tape media sequentially. When the data has been successfully written to the tape media, it may be deleted from the RAF 516 and the storage space in the RAF 516 reused to store more data from the host computer or network. The first “n” bytes of the data that were stored in the RAF 516 may optionally be retained in the RAF 516 for future use by the host system or network even after being written to the tape media.

If the tape drive 500 is able to write the data faster than the host system or network is able to send data to the tape drive 500, the portion of the RAF 516 that is allocated to this collection of data (e.g., a data file which is the data recorded between successive tape marks) will eventually be emptied. From that point, the data will be written directly to the tape media bypassing the RAF 516 completely.

If the host system or network is writing to the tape drive 500 faster than the tape drive 500 is able to write data to the tape media, then the portion of the RAF 516 that is allocated to this collection of data may eventually fill and the host computer or network will have to slow its writing rate to match that of the tape drive.

When the host computer or network has finished writing its data to the tape drive 500, it will issue a positioning command such as a reposition. The tape drive 500 (i.e., the tape storage function and the RAF 516) will respond to the positioning command and allow the host computer or network to go on to other tasks while the tape drive 500 finishes its data movement tasks (e.g., while the remainder of the data is moved from the RAF 516 to the tape media—this applies to both the holding buffer approach and the pass through buffer approach).

Rather than repositioning and removing the tape, the host system or network may wish to reposition and access a different file on the tape while the tape drive 500 is finishing the data movement tasks outlined here. Within the limits of data (in the case of reading) or space (in the case of writing) being available in the RAF 516, the new read/write operations can proceed in parallel with the finishing of the data movement tasks described earlier.

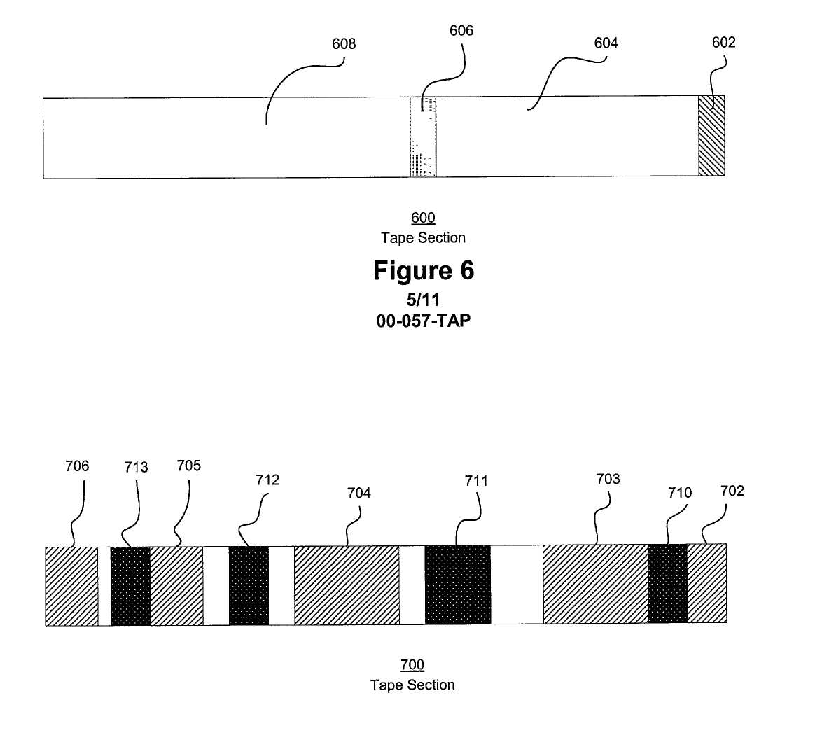

Referring now to FIG. 6, a schematic diagram of a section of tape illustrating a method of writing data to tape is depicted in accordance with the present invention. Tape section 600 is an example of a section of a tape, such as, for example, tape 522 in FIG. 5. Tape section 602 is the beginning-of-tape (BOT) marker. Once the tape has been mounted on the tape drive, such as, for example, tape drive 500 in FIG. 5, the tape is advanced by a length sufficient to allow an area of tape 604 sufficient such that the data previously written to the RAF may be written onto the tape. The amount of tape to be advanced is determined by the amount of data that can be placed on a unit length of tape divided into the amount of data written to the RAF. Once the tape has been advanced sufficiently, a file marker 606 is placed on tape section 600 to indicate the point at which data will be written directly to tape rather than through the intermediary RAF and then the remaining amount of data from the host computer or network is written into section 608. Once the host computer or network has finished writing data to the tape, the tape is repositioned and the portion of data previously written to the RAF is written to tape area 604.

By storing the first portion of data both on the RAF and on tape section 604 and by having a file marker 606, when the data is later retrieved from the tape, the host computer or network can read the portion of the data stored on tape section 604 from the disk drive while the tape is being loaded onto the tape drive. Then, the tape can be advanced to the file marker 606 and the remaining portion of the data read from the tape into the host computer or network, thereby speeding up the host computer's or network's access to the data on the tape.

A tape drive having an incorporated disk drive, such as, for example, tape drive 500 in FIG. 5, according to the present invention, provides other speed advantages as well. For example, the reading of individual files rather than the entire tape volume may be sped up using the present invention.

With reference to FIG. 7, a schematic diagram of a section of a tape illustrating the retrieval of files from a tape is depicted in accordance with the present invention. Tape section 700 contains two files. A first file has data located at tape sections 702-706, while a second file has data located at tape sections 710-713. If a host computer or network requests to retrieve the first file, all of the data in tape section 700 must be read or skipped over in order to access all of the data for the first file. The tape drive according to the present invention stores all the data read from tape section 700 to a RAF, such as, for example, RAF 516 in tape drive 500 depicted in FIG. 5. Thus, if the host computer or network later requests to retrieve the second file, rather than having to reposition the tape and reread tape section 700, the tape drive can provide the data for the second file to the host computer or network using the copy stored on the RAF. Thus, a faster retrieval of files from the tape is provided by the present invention in some circumstances. Obviously, however, if the second file was contained on a portion of a tape which was not read by the tape drive in retrieving the first file, no advantage would be gained by the tape drive of the present invention.

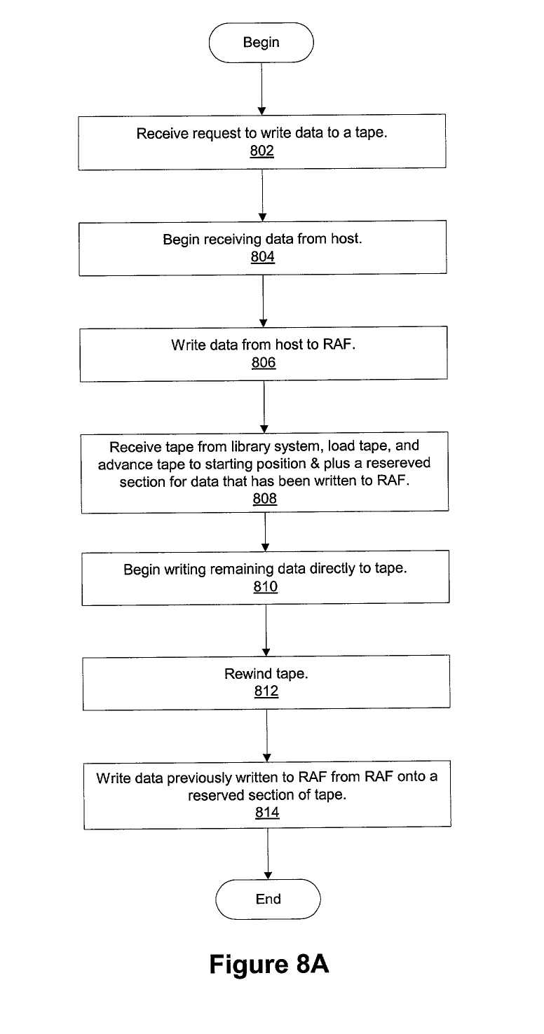

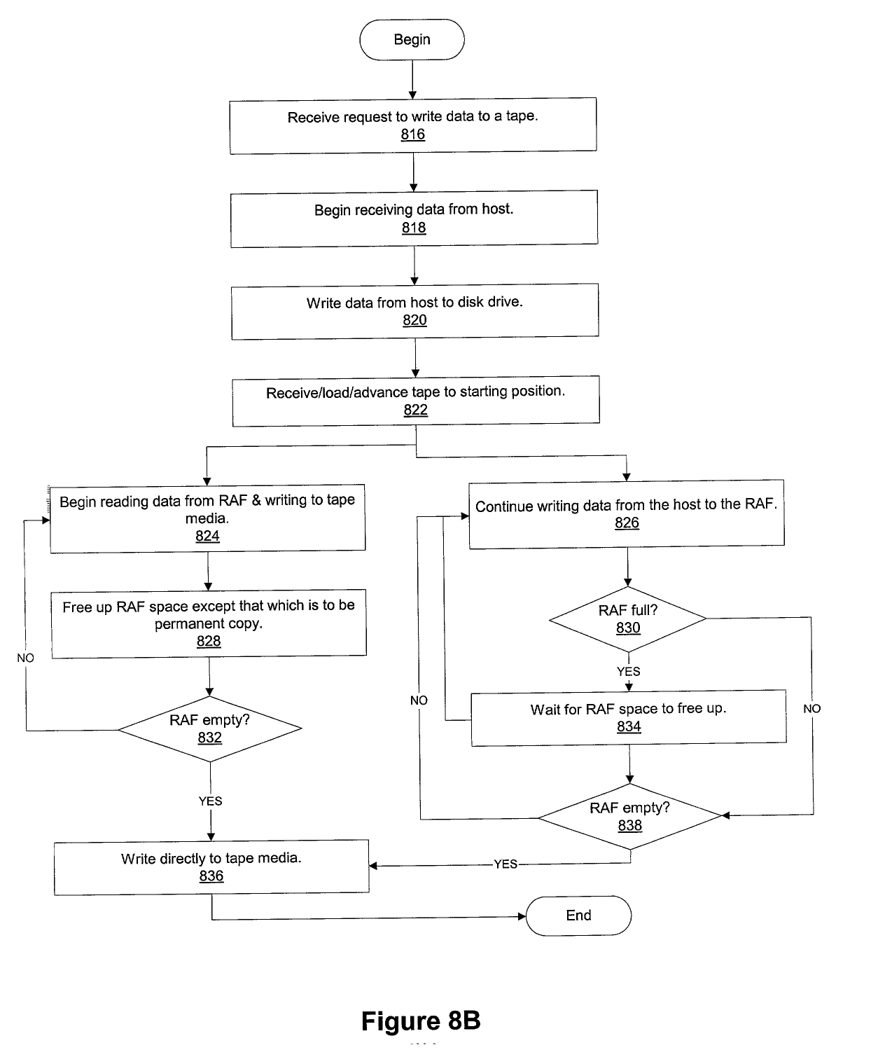

With reference now to FIG. 8A, a flowchart illustrating an exemplary method of writing data to tape using the tape drive of the present invention is depicted. When a tape drive, such as, for example, tape drive 500 in FIG. 5, receives a request to write data to a tape (step 802) and begins receiving the data to be written to tape from the host computer or network (step 804), the tape drive initially writes the received data to a RAF (step 806) while the tape drive waits for the appropriate tape to be retrieved from a library storage module, such as, for example, LSM 108 in FIG. 1. Once the tape is received from the storage library and loaded onto the tape drive, the tape is advanced to its starting position and further advanced past a reserved section necessary to later store the data that is in the RAF(step 808). The starting position, as discussed above, is determined by the amount of space on the tape necessary to hold the data that has been and will be written to the RAF before the tape is loaded and advanced to a position to receive data. Once the tape has been advanced to the appropriate starting position, the tape drive begins to write the data currently coming from the host computer or network to the tape (step 810). Once the tape drive has completed receiving data from the host computer or network and has written the final data to the tape, the tape is repositioned to the starting position of this data file (step 812) and the initial data previously stored on the RAF is then written onto the first part of the tape that had been reserved (step 814). The data stored on the RAF remains there associated with the appropriate tape such that if a host computer or network later wished to read the data from the tape at a later time, this data can be sent to the host computer or network as the tape is being loaded, thereby reducing the time necessary to retrieve the data.

With reference now to FIG. 8B, a flowchart illustrating an exemplary method of writing data to tape using the tape drive of the present invention is depicted. As above, when a tape drive, such as, for example, tape drive 500 in FIG. 5, receives a request to write data to a tape (step 816) and begins receiving the data to be written to tape from the host computer or network (step 818), the tape drive initially writes the received data to a RAF (step 820) while the tape drive waits for the appropriate tape to be retrieved from a library storage module, such as, for example, LSM 108 in FIG. 1. Once the tape is received from the storage library and loaded onto the tape drive, the tape is advanced to its starting position and further advanced past a reserved section necessary to later store the data that is in the RAF (step 822). The starting position, as discussed above, is determined by the amount of space on the tape necessary to hold the data that has been and will be written to the RAF before the tape is loaded and advanced to a position to receive data. Once the tape has been advanced to the appropriate starting position, the tape drive begins reading data from the RAF and writing data to the tape media (step 824). While the tape drive is writing data to the tape media, the tape drive also continues to write data from the host computer or network to the RAF (step 826).

After data has been written to tape (step 824), the tape drive frees up RAF space except for that which is to be permanent copy in the RAF (step 828). Next, if the RAF is not empty (step 832), the tape drive continues to read data from the RAF and write data to the tape media (step 824). Once the RAF is empty (step 832), the tape drive begins to write data directly to the tape media (step 836).

While the tape drive is writing data from the RAF to the tape media (steps 824-832), the tape drive continues to write data from the host computer or network to the RAF (step 826). If the RAF becomes full (step 830), the tape drive waits for RAF space to free up (step 834) and then continues writing data from the host computer or network to the RAF (step 826). If the RAF is not full (step 830), then the tape drive determines whether the RAF is empty (step 838). If the RAF is not empty (step 838), then the tape drive continues writing data from the host computer or network to the RAF (step 826). If the RAF is empty (step 838), then the tape drive writes data directly to the tape media (step 836).

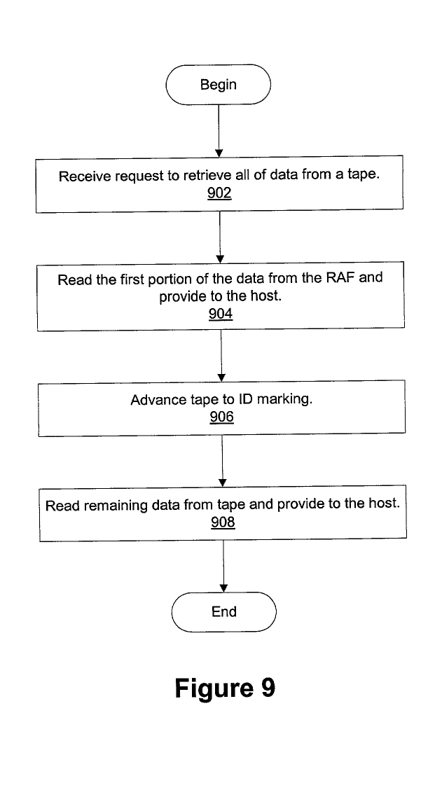

With reference now to FIG. 9, a flowchart illustrating an exemplary method of reading an entire tape from a tape drive according to the present invention is depicted. Initially, the tape drive, such as, for example, tape drive 500 in FIG. 5, receives a request to retrieve the entire contents of a tape (step 902) stored in an LSM, such as, for example, LSM 108 in FIG. 1. The tape drive reads the first portion of the data from the PAF and provides this data to the host computer or network while the tape is being retrieved and loaded onto the tape drive (step 904). This first portion of the data has been previously stored on the RAF as discussed above relative to FIG. 8A. Once the tape has been retrieved and loaded onto the tape drive, the tape is advanced to the identifying marking indicating the part of the tape that contains data that has not also been stored on the RAF (step 906). The tape drive then reads the remaining data from the tape and provides this data to the host computer or network (step 908).

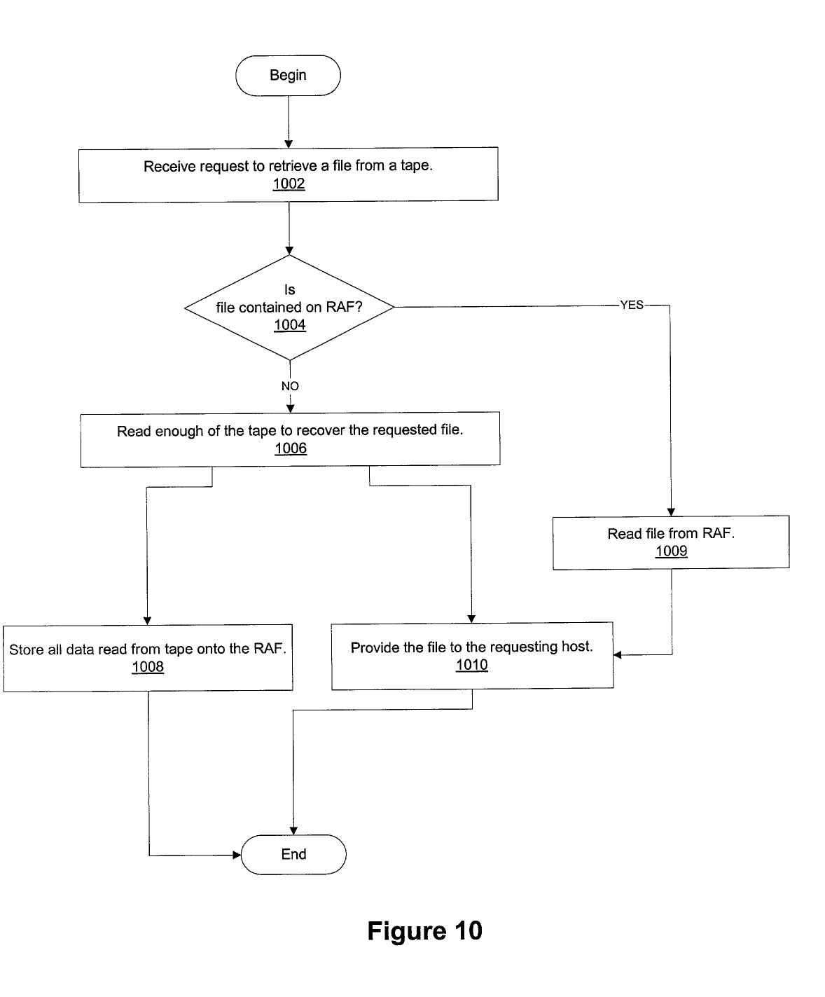

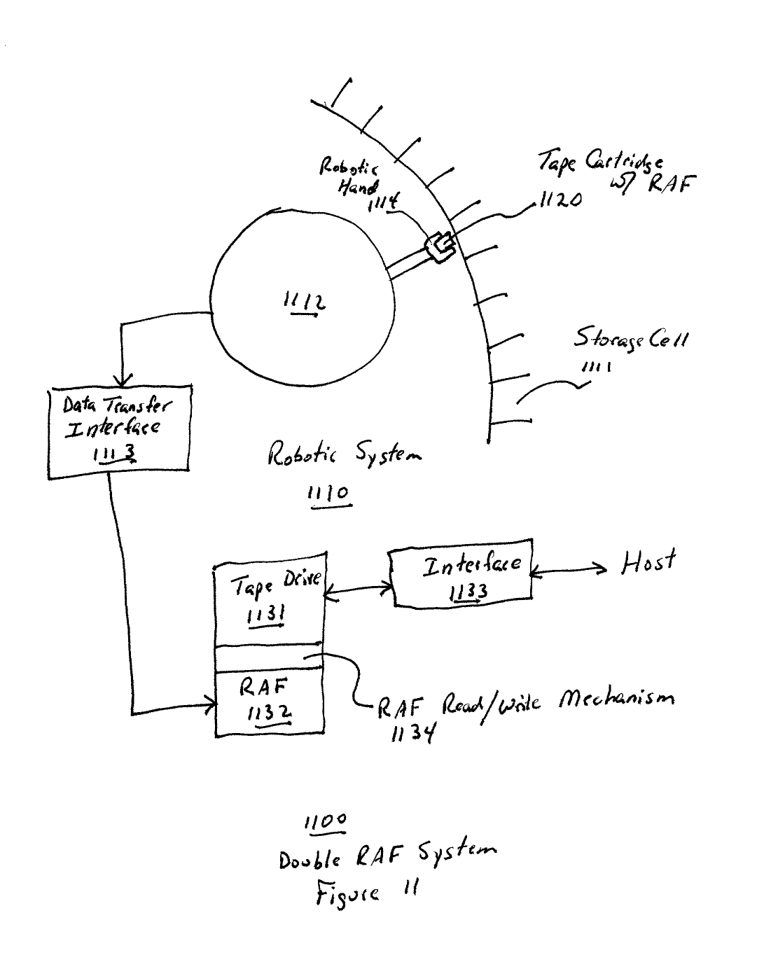

With reference now to FIG. 10, a flowchart illustrating an exemplary method of retrieving specific data files from a tape using a tape drive according to the present invention is depicted. Once the tape drive receives a request to retrieve a specific file from a tape (step 1002), the tape drive initially checks the contents of the RAF to determine whether that file has been previously recorded to the RAF (step 1004). The file may have been part of a section of data read from the tape that had been stored on the RAF in case another file was needed as discussed above. If the file is contained on the RAF, then the tape drive reads the file from the RAF (step 1009) and provides the files to the requesting host computer or network (step 1010).

If the file is not contained on the RAF, then the tape drive retrieves the tape if necessary and reads the portion of the tape containing the requested file (step 1006). The tape drive may have to read data not associated with the requested file in order to find and read all of the data corresponding to the file requested by the host computer or network. The tape drive stores all the data read from the tape onto the RAF, including those portions associated with other files (step 1008). Thus, if the host computer or network later requests a file that has already been read by the tape drive, the tape drive can retrieve that file directly from the disk drive and provide it to the host computer or network rather than repositioning the tape and re-reading the relevant portions of the data to retrieve the data a second time and thus costing time. As the data corresponding to the relevant file is read from the tape, that data is provided to the host computer or network until the entire requested file has been read and provided to the host computer or network (step 1010).

In other embodiments of the present invention, if the tape library system in which the tape drive is contained contains multiple tape drives, each tape drive may access and utilize the RAF of other tape drives in order to save and/or retrieve information to improve the performance of the overall tape library system.

In addition to the embodiment shown in FIG. 5, the RAF 516 can also be packaged with the removable media. This can be instead of or in addition to the RAF 516 being packaged with the tape drive. Typically tape cartridges are used as offline or Nearline storage media. However, other forms of media are also used, such as magnetic or optical disks, optical tape, holography, or even complete disk drives. It is possible to configure a form of RAF that would be effective for each of these forms of removable.

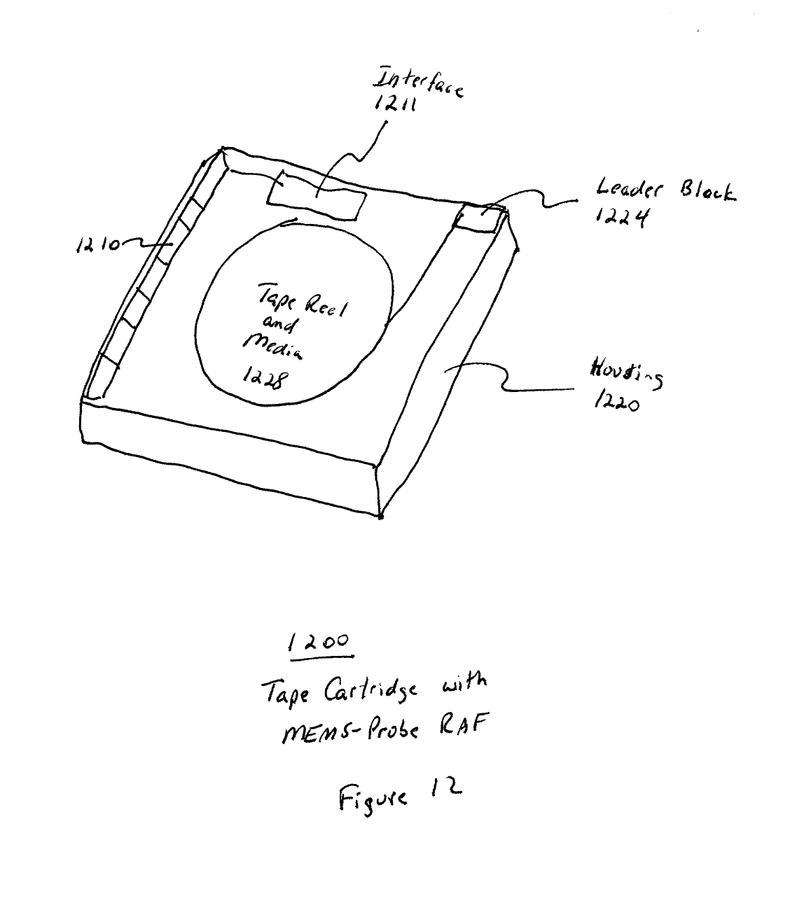

With reference now to FIGS. 11 and 12, FIG. 11 depicts a schematic diagram of a double RAF system in accordance with the present invention and FIG. 12 depicts a schematic diagram of a tape cartridge 1200 for use with double RAF system 1100 in FIG. 11 in accordance with the present invention. Tape cartridge 1200 includes a MEMS-Probe storage cells used as the RAF 1210 with a read/write/power/control interface 1211 that is accessed by the robotic hand (see FIG. 11—Robotic hand 1114). The RAF 1210 is housed in a tape cartridge housing 1220. The tape cartridge housing 1220 also houses the tape reel and media 1228, the interface 1211, and the leader block 1224 for loading the tape once mounted. Note that the RAF 1210 could be implemented with other technologies (e.g. miniature disk drives, solid state memory or the like). The RAF 1210 is accessed, powered and controlled via the interface 1211 through the Robotic hand 1114 when the tape cartridge is retrieved from the tape cartridge storage cell 1111. The data is transferred via the interface 1113 to the tape drive buffer or to the RAF 1132 (this is the same function as the RAF 516) associated with the tape drive and is thereby available to the host computer or network while the cartridge is in transit to the drive. While these figures only show reading of the RAF 1210 by the robotic hand, it anticipates being able to write as well. It would be possible for the robotic hand to access the tape cartridge and for all the data to be transferred from the host computer or network to the tape drive and from there to the RAF 1210 and this entire operation to be complete before the cartridge ever reaches the drive. In this case the cartridge might be replaced in the cartridge storage cell 1111 and never be mounted in the tape drive.

Yet another embodiment provides the storage cell 1111 with access, control, and power connections. In this implementation, the RAF is fully available while the cartridge is in storage.

The data written to the RAF 1210 might include at least some of the following applications which is not meant to be exhaustive. Those skilled in the art will be able to identify additions to these applications of this invention are realized.

Possible RAF 1210 data items:

1. The first few files on a tape that are typically used for label processing;

2. The location of every tape mark or other data separators used;

3. The location of defects in the tape media; and

4. The first “n” bytes of each “file” written to the tape media.

A “file” is defined as that portion of data that is written between data separator marks such as tape marks. The amount of data “n” can be algorithmically determined based on performance requirements associated with the tape system. An example calculation is shown here:

n=(expected mount/load/search time)×(Requested effective data transfer rate of the tape drive)

e.g., n₁=(4 sec.+2 sec.+1 sec. {first file})×(50 MB/sec)

n₁=350 MB

e.g., n₂=(4 sec.+2 sec.+20 sec. {mid tape file})×(50 MB/sec)

n₂=1300 MB

In the example of a RAF provided by MEMS-Probe chips, they might hold several gigabytes of data and several chips could be housed in a single cartridge, the amount of storage required for a series of files can easily be accommodated.

It is important to note that while the tape drive of the present invention has been described in the context of a fully functional automated tape retrieval library system, the tape drive may be implemented in other contexts as well and is not limited to use with an automated tape retrieval library system.

It is also important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out'the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A removable media device drive, comprising:
read/write heads for reading and writing data from and to a removable media;
a random access function device communicably coupled to the read/write heads; and
an interface communicably coupled to the read/write heads and to the random access function device for allowing the removable media device drive to exchange data with a host.

2. The removable media device drive as recite in claim 1, wherein the random access function device is a disk drive.

3. The removable media device drive as recited in claim 1, wherein the random access function device is a micro electrical mechanical systems probe storage device.

4. The removable media device drive as recited in claim 1, further comprising:
a memory for storing instructions on a method of reading data from and writing data to the removable media; and
a microprocessor for executing the instructions stored in the memory.

5. The removable media device drive as recited in claim 1, wherein initial data received from the host is written to the random access function device during a time period in which a removable media is retrieved and loaded into the removable media device drive, final data is written to a second portion of the removable media, and the initial data is written to a reserved first portion of the removable media after completion of the writing of the final data to the removable media and after the removable media has been repositioned to the reserved first portion of the removable media.

6. The removable media device drive as recited in claim 1, wherein the random access function device is a first random access function device and data is read from a second random access function device in a cartridge to the first random access function device in the removable media device drive while the cartridge is in transit to the removable media device drive.

7. The removable media device drive as recited in claim 1, wherein the random access function device is a first random access function device and data is read from a second random access function device in a cartridge to a buffer in the removable media device drive while the cartridge is in transit to the removable media device drive.

8. The removable media device drive as recited in claim 1, wherein the random access function device is used as a pass through buffer and data is written to a removable media in the removable media device drive starting at a first byte received from a host.

9. The removable media device drive as recited in claim 8, wherein some of the data is retained in the random access function device indefinitely for subsequent fast access by the removable media device drive.

10. The removable media device drive as recited in claim 1, wherein a initial portion of data contained on the removable media is also stored on the random access function device and, when data from the removable media is requested by the host, the initial portion of the data is provided to the host from the random access function device while the requested media is retrieved, loaded into the removable media device drive, and made ready for access.

11. The removable media device drive as recited in claim 1, wherein an section of data read in order to retrieve a file is stored on the disk drive such that, if the host later requests additional data that has been previously read, that additional data is retrieved and provided to the host from the random access function device.

12. The removable media device drive as recited in claim 1, wherein the removable media is a magnetic tape.

13. The removable media device drive as recited in claim 1, wherein the removable media is an optical disk.

14. The removable media device drive as recited in claim 1, wherein the removable media is an optical tape.

15. The removable media device drive as recited in claim 1, wherein the removable media is a holographic device.

16. The removable media device drive as recited in claim 1, wherein the removable media is a solid state device.

17. The removable media device drive as recited in claim 1, wherein the removable media is a magnetic disk.

18. The removable media device drive as recited in claim 1, wherein the random access function devices is a solid state memory device.

19. A removable media storage sys tem, comprising:
a library storage module for storing a plurality of removable data storage media;
a removable media device drive for reading and writing data to the removable data storage media, wherein the removable media device drive comprises:
read/write heads for reading data from and writing data to the removable data storage media;
a random access function device communicably coupled to the read/write heads; and
an interface communicably coupled to the random access function device and to the read/write heads for transmitting data to and receiving data from a host; and
a robotic hand for moving a one of the removable data storage media between the library storage module and the removable media device drive.

20. The removable media storage system as recited in claim 19, wherein data is written to the random access storage device and to one of the removable data storage media substantially simultaneously.

21. The removable media storage system as recited in claim 19, wherein the random access function device holds a location information for each subset of data on a plurality of removable data storage media.

22. The removable media storage system as recited in claim 19, wherein the random access function device holds a location information for each defect in a plurality of the removable data storage media.

23. The removable media storage system as recited in claim 19, wherein the random access function device holds a first portion of data of each data file on a plurality of the data storage tapes.

24. The removable media storage system as recited in claim 19, wherein the removable media device drive is a first removable media device drive and the random access function device is a first random access function device and further comprising:
a second removable media device drive comprising a second random access function device, wherein the first removable media device drive may access the second random access function device.

25. The removable media storage system as recited in claim 19, wherein the removable data storage media is a magnetic tape.

26. The removable media storage system as recited in claim 19, wherein the removable data storage media is an optical tape.

27. The removable media storage system as recited in claim 19, wherein the removable data storage media is an optical disk.

28. The removable media storage system as recited in claim 19, wherein the removable data storage media is an holographic device.

29. The removable media storage system as recited in claim 19, wherein the removable data storage media is a magnetic disk.

30. The removable media storage system as recited in claim 19, wherein the removable data storage media is a solid state memory.

31. The removable media storage system as recited in claim 19, wherein the random access function device is a solid state memory.

32. The removable media storage system as recited in claim 19, wherein the random access function device is a disk drive.

33. The removable media storage system as recited in claim 19, wherein the random access function device is a micro electrical mechanical-probe system.

34. The removable media storage system as recited in claim 19, wherein access, control, and power connections for the removable media device drive are located on the robotic hand.

35. The removable media storage system as recited in claim 19, wherein access, control, and power connections for the removable media device drive are located in a storage cell.

36. A method of writing data to a removable data storage media, the method comprising:
receiving an initial portion of data from a host;
writing the initial portion of data to a random access function device while retrieving and mounting a removable media on a removable media drive;
after the removable media has been mounted, creating a reserved portion of removable media by advancing the removable media by an amount sufficient to store the initial data stored on the random access function device;
writing a final portion of data to the removable media;
repositioning the removable media; and
writing the initial portion of data read from the random access function device onto the reserved portion of the removable media.

37. A method of retrieving data from a removable media, the method comprising:
receiving a request to retrieve data from a removable media;
retrieving a first portion of the data from a random access function device while the removable media is being retrieved; and
retrieving a remaining portion of the data from the removable media after the removable media has been retrieved.

38. The method as recited in claim 37, wherein the data comprises an entire amount of data contained on the removable media.

39. A method of retrieving data from a removable media, the method comprising:
receiving a request for a requested file from a removable media;
responsive to a determination that the requested file is contained on a random access function device, retrieving the requested file from the random access function device and providing the requested file to a requesting host.

40. The method as recited in claim 39, further comprising:
responsive to a determination that the file is not contained on the random access function device, reading a sufficient amount of the removable media to obtain the requested file;
providing the requested file to the requesting host; and
storing all information read from the removable media in obtaining the requested file such that if the requesting host later requests a second file that, if the second file was read by the removable media drive in obtaining the requested file, that such second file may be retrieved from the random access function device without reading the removable media a second time.

41. A computer program product in a computer readable media for use in a data processing system for writing data to a removable data storage media, the computer program product comprising:
receiving instructions for receiving an initial portion of data from a host;
writing instructions for writing the initial portion of data to a random access function device while retrieving and mounting a removable media on a removable media drive;
creating instructions for, after the removable media has been mounted, creating a reserved portion of removable media by advancing the removable media by an amount sufficient to store the initial data stored on the random access function device;
writing instructions for writing a final portion of data to the removable media;
repositioning instructions for repositioning the removable media; and
writing instructions for writing the initial portion of data read from the random access function device onto the reserved portion of the removable media.

42. A computer program product in a computer readable media for use in a data processing system for retrieving data from a removable media, the computer program product comprising:
receiving instructions for receiving a request to retrieve data from a removable media;
first retrieving instructions for retrieving a first portion of the data from a random access function device while the removable media is being retrieved; and
second retrieving instructions for retrieving a remaining portion of the data from the removable media after the removable media has been retrieved.

43. The computer program product as recited in claim 42, wherein the data comprises an entire amount of data contained on the removable media.

44. A computer program product in a computer readable media for use in a data processing system for retrieving data from a removable media, the computer program product comprising:
receiving instructions for receiving a request for a requested file from a removable media;
retrieving instructions, responsive to a determination that the requested file is contained on a random access function device, for retrieving the requested file from the random access function device and providing the requested file to a requesting host.

45. The computer program product as recited in claim 44, further comprising:
reading instructions, responsive to a determination that the file is not contained on the random access function device, for reading a sufficient amount of the removable media to obtain the requested file;
providing instructions for providing the requested file to the requesting host; and
storing instructions for storing all information read from the removable media in obtaining the requested file such that if the requesting host later requests a second file that, if the second file was read by the removable media drive in obtaining the requested file, that such second file may be retrieved from the random access function device without reading the removable media a second time.

46. A system for writing data to a removable data storage media, the system comprising:
receiving means for receiving an initial portion of data from a host;
writing means for writing the initial portion of data to a random access function device while retrieving and mounting a removable media on a removable media drive;
creating means for, after the removable media has been mounted, creating a reserved portion of removable media by advancing the removable media by an amount sufficient to store the initial data stored on the random access function device;
writing means for writing a final portion of data to the removable media;
repositioning means for repositioning the removable media; and
writing means for writing the initial portion of data read from the random access function device onto the reserved portion of the removable media.

47. A system for retrieving data from a removable media, the system comprising:
receiving means for receiving a request to retrieve data from a removable media;
first retrieving means for retrieving a first portion of the data from a random access function device while the removable media is being retrieved; and
second retrieving means for retrieving a remaining portion of the data from the removable media after the removable media has been retrieved.

48. The system as recited in claim 47, wherein the data comprises an entire amount of data contained on the removable media.

49. A system for retrieving data from a removable media, the system comprising:
receiving means for receiving a request for a requested file from a removable media;
retrieving means, responsive to a determination that the requested file is contained on a random access function device, for retrieving the requested file from the random access function device and providing the requested file to a requesting host.

50. The system as recited in claim 49, further comprising:
reading means, responsive to a determination that the file is not contained on the random access function device, for reading a sufficient amount of the removable media to obtain the requested file;
providing means for providing the requested file to the requesting host; and
storing means for storing all information read from the removable media in obtaining the requested file such that if the requesting host later requests a second file that, if the second file was read by the removable media drive in obtaining the requested file, that such second file may be retrieved from the random access function device without reading the removable media a second time.
